(19) United States
(12) Patent Application Publication
(10) Pub. No.: US 2007/0125310 A1
(43) Pub. Date: Jun. 7, 2007

(54) Grooming device for animals

(75) Inventors: Jayne A. Oberstadt, New London, WI (US); Wendy L. Behnke, Atlanta, GA (US); Amanda L. O'Connor, Appleton, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/294,982

(22) Filed: Dec. 5, 2005

(51) Int. Cl. A01K 13/00

(52) U.S. Cl. 119/601; 119/600

(57) ABSTRACT

The present invention provides an animal grooming device including a front layer including a first material, wherein the front layer has a front layer perimetric edge, and a backing layer including a second material, wherein the backing layer has a backing layer perimetric edge, and wherein at least a portion of the backing layer perimetric edge is coupled to the front layer perimetric edge such that the front and backing layers define a bag-like space. The device also includes a device tip opposite the opening; and a hair collection mechanism coupled to the front layer, the hair collection mechanism including a section having a plurality of primary hooks, wherein each primary hook is unidirectional and has an orientation, a plurality of secondary hooks, wherein each secondary hook is bidirectional, and an anchoring layer to which the primary and secondary hooks are attached.

### BACKGROUND

This invention pertains to a device for grooming and controlling shedding in pets and other animals.

Owners of pets and other animals usually face the prospect of repeatedly and often cleaning fur, hair, and dander from various surfaces including carpets, furniture, and the pets themselves. A pet that is not frequently groomed can encounter several issues: an unhealthy appearance, unfavorable odor, and an increased amount of dander and shed hair. All of these issues can have a negative impact; the dander, for example, can lead to allergy related symptoms and discomfort for the pet's household. It is typically advantageous to attract such fur, hair, and dander at their source, the animal itself, before they have a chance to be deposited. Various devices exist for collecting fur, hair, and dander shed by animals, including devices that employ adhesive sections to which the fur, hair, and dander may stick, and durable devices such as brushes.

### SUMMARY OF THE INVENTION

There are disadvantages to using such devices. Durable devices may remove hair from pets but require storage. These durable devices also retain hair/dander on the bristles after use and will release this hair/dander into the air to trigger the issues noted above. Durable devices need to be cleaned frequently. In addition, some pets prefer to not be groomed by such devices. Disposable hair removal products are often ineffective at removing hair from a pet's coat. Adhesive-based devices tend to quickly become matted with fur and hair, greatly decreasing their effectiveness. As a result, shedding is less controlled and hair and fur become deposited throughout the range of the animal.

The invention disclosed herein solves these problems by providing an improved disposable grooming device including hook-type material and a shape that allows for ease of use. Such a device allows a consumer to collect pet dander and the like before it is shed by the animal.

The present invention overcomes these problems by providing an animal grooming device including a front layer including a first material, wherein the front layer has a front layer perimetric edge, and a backing layer including a second material, wherein the backing layer has a backing layer perimetric edge, and wherein at least a portion of the backing layer perimetric edge is coupled to the front layer perimetric edge such that the front and backing layers define a bag-like space. The device also includes a device tip opposite the opening; and a hair collection mechanism coupled to the front layer, the hair collection mechanism including a section having a plurality of primary hooks, wherein each primary hook is unidirectional and has an orientation, a plurality of secondary hooks, wherein each secondary hook is bidirectional, and an anchoring layer to which the primary and secondary hooks are attached.

The present invention also provides an animal grooming device including a front layer including a first material, wherein the front layer has a front layer perimetric edge, and a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool. The device also includes a device tip opposite the opening; a hair collection mechanism coupled to the front layer, the hair collection mechanism including a section including a plurality of primary hooks, wherein each primary hook is unidirectional and has an orientation, an anchoring layer to which the primary hooks are attached, wherein each section is aligned in parallel with the opening;

and a longitudinal line extending between the opening and the device tip, wherein the orientation of each primary hook is away from the longitudinal line.

The present invention also provides an animal grooming device including a front layer including a first material, wherein the front layer has a front layer perimetric edge, and a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool. The device also includes a device tip opposite the opening; a hair collection mechanism coupled to the front layer, the hair collection mechanism including a plurality of sections, each section including a plurality of primary hooks, wherein each primary hook is unidirectional and has an orientation, and an anchoring layer to which the primary hooks are attached; and a longitudinal line extending from the opening to the device tip, wherein the orientation of each primary hook is the same and perpendicular to the longitudinal line, and wherein each section is aligned perpendicularly to the longitudinal line.

The present invention also provides a method for controlling animal shedding, the method including donning a device having a front layer including a first material, wherein the front layer has a front layer perimetric edge, and a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool.

The device also includes a device tip opposite the opening, and a hair collection mechanism coupled to the front layer, the hair collection mechanism including a section including a plurality of primary hooks, wherein each primary hook is unidirectional and has an orientation, a plurality of secondary hooks, wherein each secondary hook is bidirectional, and an anchoring layer to which the primary and secondary hooks are attached. The method also includes petting an animal having detritus such that detritus is captured in the hooks and disposing of the device.

The present invention also provides an animal grooming device including a front layer including a first material, wherein the front layer has a front layer perimetric edge, and a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool. The device also includes a device tip opposite the opening; a hair collection mechanism coupled to the front layer, the hair collection mechanism including a plurality of sections, each section including a plurality of primary hooks, wherein each primary hook is unidirectional and has an orientation, a plurality of secondary hooks, wherein each secondary hook is bidirectional, and an anchoring layer to which the primary and secondary hooks are attached. The device also includes a thumb hole in one of or between the front and backing layers, and a longitudinal line extending between the opening and the device tip, wherein the orientation of each primary hook is away from the longitudinal line, wherein each section is aligned perpendicularly to the longitudinal line, and wherein the front layer is attached to the backing layer at points or a line on the longitudinal line.

Other objects and advantages of the present invention will become more apparent to those skilled in the art in view of the following description and the accompanying drawings.

### BRIEF DESCRIPTION OF THE DRAWINGS

FIG. 1 is a schematic view of the front and back of a shedding control device of the present invention.

FIG. 2 is a schematic profile view of a primary hook and a secondary hook of the device of FIG. 1.

FIG. 3 is a schematic view of the front and back of another aspect of the device of FIG. 1.

### DETAILED DESCRIPTION OF THE PREFERRED EMBODIMENTS

The invention described herein is a shedding control device 10. Such a device 10 allows a consumer to groom and control shedding in a pet or other animal, including a human. For grooming and shedding control, the user needs to capture primarily fur, hair, dander, debris, and loose organic material, collectively referred to herein as detritus.

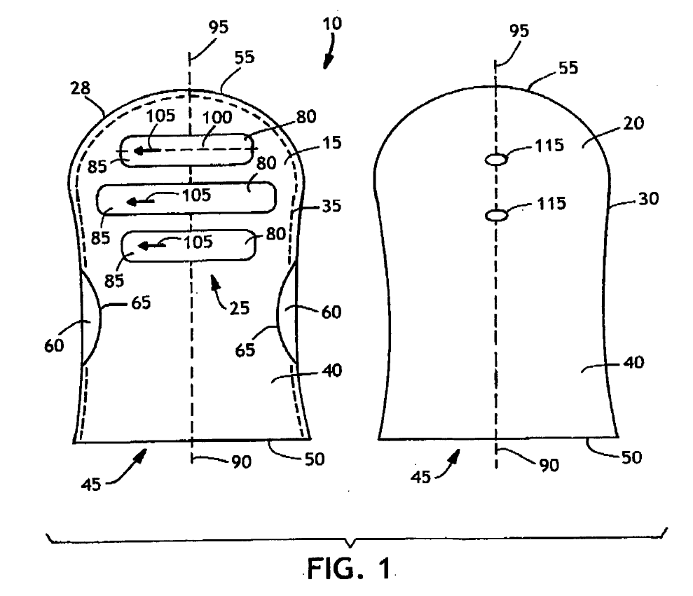

FIG. 1 illustrates an example of a shedding control device 10 of the present invention. The device 10 includes a front layer 15, a backing layer 20, and a hair collection mechanism 25. For purposes of illustration, and not for purposes of limitation, the shedding control device 10 is described as a mitt. The same device 10, however, may be described as any other suitable form of a shedding control device 10, including as a finger glove, a pad, or as a cover for an animal grooming tool. The shedding control device 10 may also be used for the purposes of grooming.

The device 10 includes a front layer 15. The front layer 15 may be of any suitable shape, but is preferably generally planar and is further preferably generally rectangular or oblong. The front layer 15 has a perimetric edge 28 extending around the front layer 15.

In one aspect of the present invention, the front layer 15 is generally the size of a human hand held flat on a surface. In an alternative aspect of the present invention, the front layer 15 is generally the size of a grooming tool. In general, the front layer 15 may be of any suitable size, with the size preferably selected to be suitable for the intended use of the device 10.

In one aspect of the present invention, the front layer 15 includes a spunlace cover with a basis weight of 65 grams per square meter. In other aspects of the present invention, the front layer 15 may include any suitable nonwoven or woven materials or polymer sheeting of any suitable basis weight. The material of the front layer 15 can act to protect a user's hand from contacting the coat of the animal and as a carrier sheet for the hair collection mechanism 25.

The device 10 also includes a backing layer 20. The backing layer 20 is preferably of the same general size and shape of the front layer 15, although the size and/or shape of the backing layer 20 may be selected to be different from the size and/or shape of the front layer 15 based on the intended use of the device 10. The backing layer 20 has a perimetric edge 30 extending around the perimeter of the backing layer 20.

In one aspect of the present invention, the backing layer 20 includes a stretchable nonwoven sheet. In other aspects of the present invention, the backing layer 20 may be a stretch bonded laminate, a non-stretchable nonwoven, or any other suitable nonwoven material, woven material, or polymer sheet, including, for example, paper tissue. The backing layer 20 may also be manufactured from an elastomeric material to allow for a more snug fit on the user's hand or a grooming tool. The material of the backing layer 20 can act to enclose the user's hand and protect the hand from coat contact, in addition to maintaining a snug fit on the user's hand during use of the device 10.

In an alternative aspect of the present invention, one or both of the front and backing layers 15, 20 may be breathable to allow air to circulate through the device 10.

The front layer 15 is coupled to the backing layer 20. One of the front and backing layers 15, 20 is positioned to overlie the other of the front and backing layers 15, 20, such that the perimetric edges 28, 30 of the front and backing layers 15, 20 generally align. A portion of the perimetric edge 28 of the front layer 15 is attached to the perimetric edge 30 of the backing layer 20 to form a seam 35. The seam 35 formed may be at the perimetric edges 28, 30, or the seam 35 may be adjacent or inward from the perimetric edges 28, 30. The perimetric edges 28, 30 may be attached by adhesive, ultrasonic bonding, heating, sewing, or by any other suitable method.

Coupling the front layer 15 to the backing layer 20 forms the device 10 with a bag-like structure having an outer surface 40 and an interior space 45 with an opening 50.

Opposite the opening 50 is a device tip 55. The device 10 may be formed such that the interior space 45 is sized to accommodate a human hand, a portion of a grooming tool, or any other suitable item. Because of this bag-like design, the device 10 may be turned inside-out by a user such that the previous interior space 45 becomes the new outer surface, and the previous outer surface 40 becomes and defines the new interior space.

In turning the device 10 inside-out, any detritus captured in the hooks or adhesive on the previous outer surface 40 of the device 10 becomes captured within the new interior space of the device 10.

The device 10 may include one or more thumb holes 60. In one aspect of the present invention, the thumb holes 60 are formed as openings in the seam 35 between the front and backing layers 15, 20. Positioning thumb holes 60 on opposite sides of the device 10 allows the device 10 to be used on the user's right or left hand. In other aspects of the present invention, one or more thumb holes 60 may be positioned or formed in one or both of the front and backing layers 15, 20. The thumb holes 60 may also be partially formed with a cutout 65 in one of the front or backing layers 15, 20.

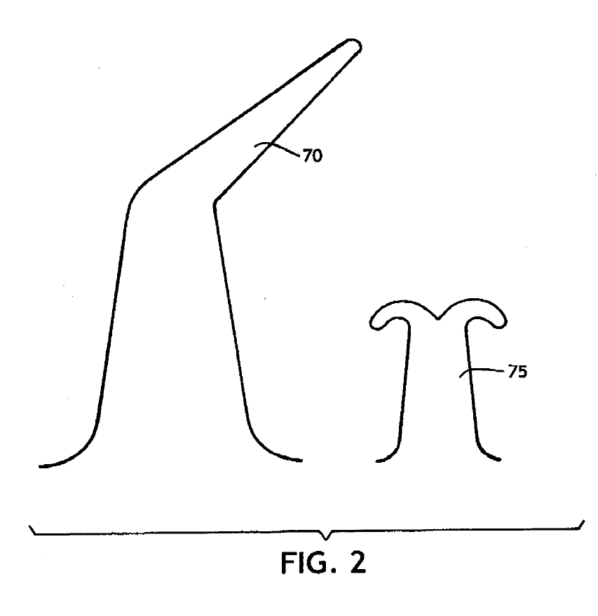

The front layer 15 supports a hair collection mechanism 25. The hair collection mechanism 25 performs the grooming and shedding-control function, which it accomplishes by including hook-type material. In one aspect of the present invention, the hook-type material is designed specifically for the collection of pet detritus and uses two separate morphologies in the form of primary hooks 70 and secondary hooks 75 (see FIG.2). In one aspect of the present invention, the primary hooks 70 have a unidirectional curvature. In an exemplary aspect of the present invention, the primary hooks 70 have a height of 0.250 inches, are formed from polyethylene, and are positioned with a density of 95 hooks per square inch. In other aspects of the present invention, primary hooks 70 of other heights, materials, densities, and directionalities may be used. The primary hook's height allows the primary hook 70 to penetrate an animal's coat but also enhances a consumer's belief in the functionality of the device 10 as it appears to be more like durable grooming utensils commercially available.

Intermixed with the primary hooks 70 are secondary hooks 75 with a smaller profile and with a double curvature feature (see FIG. 2). The secondary hooks 75 increase the capture and retention of the pet hair with continued use, especially of shorter hairs (e.g., hairs from a Labrador Retriever) as the hairs will become more easily entwined in the secondary hooks 75. The double hook matrix is preferred however other hook morphologies could be considered. Hook-type material of this type is typically available in hook and loop material such as that manufactured as VELCRO-brand hook and loop fasteners by the American Velcro Company. The hook-type material is typically formed in a continuous sheet using continuous injection molding, and the hook-type material typically includes hooks, knobs, or both. As is known in the art, the manufacturer may tailor the modulus of the hooks by the polymer that is chosen to manufacture them. In another aspect of the present invention, the hair collection mechanism 25 may include only secondary hooks 75 and no primary hooks 70.

The primary and secondary hooks 70, 75 each have a height. In one aspect of the present invention, the secondary hook height is less than about 75 percent of the primary hook height. In another aspect of the present invention, the secondary hook height is less than about 50 percent of the primary hook height. In these aspects, the differential in hook height allows for better grooming because the taller primary hooks 70 penetrate the coat of the animal to be groomed. The secondary hooks 75, because they are shorter, do not catch in the fur or hair and thus do not impede the progress of the grooming, but are still available to collect stray fur or hair.

In other aspects of the present invention, primary hook height is less than about 75 percent of the secondary hook height, or the primary hook height is less than about 50 percent of the secondary hook height. A user may find that in these aspects, the differential in hook height allows for better grooming, particularly in species with shorter coats, because the taller secondary hooks 75 collect detritus while the primary hooks 70, because they are shorter, do not penetrate the coat of the animal far enough to cause irritation to the animal's skin.

Returning to FIG. 1, the hair collection mechanism 25 further includes an anchoring layer 80 to which the primary and/or secondary hooks 70, 75 are attached. The anchoring layer 80 may be formed with the hooks in the same manufacturing process and from the same material, or may be manufactured separately from the hooks and from the same or different material from the hooks and then joined to the hooks by any suitable method. In one aspect of the present invention, the anchoring layer 80 with hooks is manufactured in a ribbon-type form and then cut into sections 85. The sections 85 are sized to fit on the front layer 15 of the device. The sections 85 are generally rectangular in shape, but can also be round, oval, square, oblong, or any other suitable shape.

To better describe the device 10, the device 10 may be defined as having a longitudinal direction extending between the opening 50 to the device tip 55. A longitudinal line 90 extends in the longitudinal direction along the device 10. The longitudinal line 90 in the center of the device 10 is a device centerline 95. The device 10 may also be defined as having a transverse direction that is perpendicular to the longitudinal direction. Each section 85 may be defined as having a section centerline 100 extending in a longitudinal direction along that section 85.

One or more sections 85 of anchoring layer 80 including primary and/or secondary hooks 70, 75 are attached to the front layer 15 of the device 10. Such section or sections 85 are attached to the front layer 15 by ultrasonic bonding, although the sections 85 may alternatively be attached by sewing, using any suitable adhesive, or by any other suitable method. The section or sections 85 may also be laminated directly to the front layer 15.

The section or sections 85 may be arranged on the front layer 15 such that the section centerline 100 of each section 85 is parallel to the device centerline 95, perpendicular to the device centerline 95, or at an acute or obtuse angle to the device centerline 95. If more than one section 85 is present, the section centerline 100 of each section 85 need not be parallel to the section centerline 100 of the other section or sections 85.

In one aspect of the present invention, the device 10 includes a plurality of sections 85 oriented such that the unidirectional primary hooks 70 of each section 85 are all oriented in the same direction 105. Such orientation allows for unidirectional grooming and maximum surface area contact between the device and the grooming subject. This aspect also allows for multiple pressure points: depending on personal grooming style, the user of the device 10 can put pressure on various areas of the device 10 while still collecting detritus.

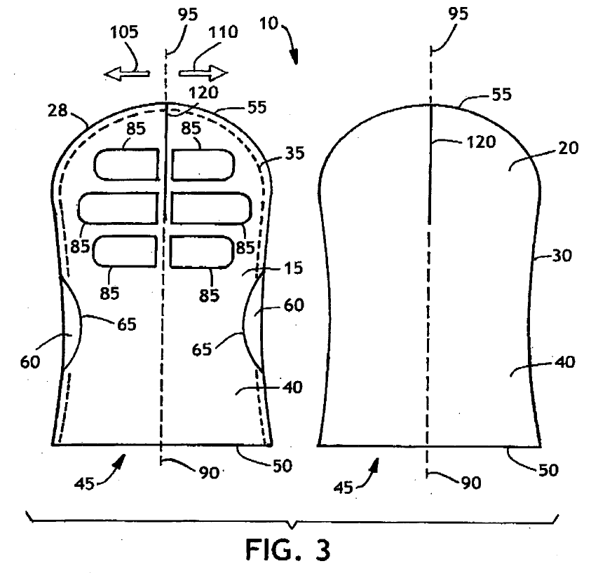

In another aspect of the present invention exemplified in FIG. 3, the device 10 includes a plurality of sections 85 oriented such that the unidirectional primary hooks 70 of the section or sections 85 in one area of like orientation are oriented in a direction different from the direction of the primary hooks 70 of the section or sections 85 in another area of like orientation. The two such areas of like orientation may be separated by the device centerline 95, by a line parallel to the device centerline 95, by a line perpendicular to the device centerline 95, or by a line at an acute or obtuse angle to the device centerline 95. In a specific example of this aspect shown in FIG. 3, the primary hooks 70 of the section or sections 85 on one side of the device centerline 95 are oriented in a direction 105 different from the direction 110 of the primary hooks 70 of the section or sections 85 on the other side of the device centerline 95. In a more specific example of this aspect, the primary hooks 70 of the section or sections 85 on either side of the device centerline 95 are oriented in a direction perpendicular to and away from the device centerline 95. Such an orientation enables multidirectional grooming allowing for ease of use for left-and right-handed users.

In other aspects of the present invention, the front layer 15 may be divided into three or more areas of like orientation.

The use of sections 85 in the hair collection mechanism 25 simplifies the manufacturing process in both the anchoring layer/hook combination manufacture as well as the device manufacture. The use of sections 85 also allows the user to easily clean detritus from the mitt for extended use, either during a single grooming session or over a multitude of grooming sessions.

In an alternative aspect of the present invention, the hair collection mechanism 25 may also include adhesive to aid in capturing detritus. The adhesive may be applied to the hook-type material and deposited between and/or at the base of the hooks. The adhesive may be applied by spraying, rolling, or by any other suitable method. The adhesive may be any suitable adhesive; one example is an adhesive that remains tacky after application such as a hot melt resin with a high tackifier level. The hook-type material itself may be produced with void spaces-areas of hook-type material that are absent of hooks. Adhesive may then be applied to the void spaces.

In an alternative aspect of the present invention, the adhesive may be applied in sections 85, alternating with sections 85 of hook-type material. In yet another aspect of the present invention, areas of adhesive may be interspersed with areas of hook-type material in any suitable pattern or dispersion.

In an alternative aspect of the present invention that is not shown, the backing layer 20 also supports a hair collection mechanism 25 and is manufactured under any aspect of the present invention described above for the front layer 15. In the case of the backing layer 20 supporting a hair collection mechanism 25, the backing layer 20 may include a different hook-type material from that which is used for the front layer 15. For example, the hook-type material of the backing layer 20 may include hooks that are larger than the hooks of the hook-type material of the front layer 15 to accommodate different grooming needs. In an alternative aspect of the present invention, one of the front and backing layers 15, 20 may include adhesive where the other does not, or one of the front and backing layers 15, 20 may include adhesive where the other includes a different adhesive.

The device 10 may be manufactured in any dimensions. For example, the device 10 as a mitt may be sized to fit best on a child's hand, an adult hand, or may be of a length to cover much of an adult's hand and arm.

In one aspect of the present invention, as illustrated in FIG. 1, the device 10 includes one or more dots 115 of stitching, glue, ultrasonic bonds, or other suitable means to couple the front layer 15 to the backing layer 20. These dots 115 help to stabilize the device 10, help to prevent rotation of the device 10 around a user's hand, and help to increase the ability of the device 10 to fit snugly on a multitude of hand sizes. In another aspect of the present invention illustrated in FIG. 3, the device 10 includes a stripe 120 of stitching, glue, ultrasonic bond, or other suitable means extending at least partially across the device 10 to couple the front layer 15 to the backing layer 20. In either aspect, the dots 115 or stripe 120 may be positioned along a longitudinal line 90, along the device centerline 95, or at various positions in the device 10. In the case of the dots 115 or stripe 120 being positioned on the device centerline 95, the device 10 is separated into two sections with two fingers of a user's hand to go to one side of the device centerline 95, and two fingers on the other side of the device centerline 95. In other aspects of the present invention, the device 10 may include more than one stripe 120 or group of dots 115, including having sufficient stripes 120 or dots 115 to divide the device 10 into pockets for each finger.

In an alternative aspect of the present invention (not shown), the device 10 may include a thumb space at least partially separated from the interior space 45 and sized to accommodate a human thumb. A thumb space helps to stabilize the device 10 in use by helping to prevent rotation of the device 10 around a user's hand. In another alternative aspect of the present invention, particularly one on which the backing layer 20 is a hair collection mechanism 25, the device 10 may also be manufactured with a second thumb space (not shown) on the opposing perimetric edge 28 of the device 10, such that one thumb space may be used when the front layer 15 is used to collect detritus, and the other thumb space (not shown) may be used when the backing layer 20 is used to collect detritus.

In still another alternative aspect of the present invention (not shown), the device 10 may include a finger loop within the space. With a finger inserted in the finger loop during use, the finger loop helps to stabilize the device 10 by helping to prevent rotation of the device 10 around a user's hand. The finger loop may be formed from any suitable material including the nonwoven described above, and may be formed with either the first or backing layers 15, 20, or formed independently of the front and backing layers 15, 20.

The finger loop may be attached to either of the first or backing layers 15, 20, or the finger 10 loop may be attached to the device 10 in conjunction with coupling the front layer 15 to the backing layer 20. The finger loop may assist a user in turning the device 10 inside-out by grasping the finger loop and pulling.

In yet another alternative aspect of the present invention (not shown), the device 10 may include a finger slit appropriately positioned in the front layer 15, backing layer 20, or both front and backing layers 15, 20. With a finger inserted through the finger slit during use, the finger slit helps to stabilize the device 10 by helping to prevent rotation of the device 10 around a user's hand.

The device 10 may be manufactured without a thumb space, a finger loop, or a finger slit. In such an aspect of the present invention, pressure from a user's fingers on the seam 35 helps to stabilize the device 10 by helping to prevent rotation of the device 10 around the user's hand.

The opening 50 of the device 10 may include a sealing mechanism (not shown) to allow the opening 50 to be closed. The sealing mechanism may be hook-type material, adhesive, a zipper-like mechanism, or any other suitable sealing mechanism. In turning the device 10 inside-out and capturing any detritus within the interior space defined by the previous outer surface 40 of the device 10, the sealing mechanism can then be used to ensure that the detritus remains within the interior space defined by the previous outer surface 40 for disposal without mess.

By virtues of the design and materials chosen for the device 10, the device 10 is preferably designed to be disposable. In this case, disposable means that the device 10 is disposed of, rather than cleaned, after use.

In an alternative aspect of the present invention of the device 10, the front layer 15 and the backing layer 20 are two portions of the same piece of material. One of the front and backing layers 15, 20 is folded over the other of the front and backing layers 15, 20 and a portion of their perimetric edges 28, 30 are coupled by any means described herein to form the device 10.

In use of the device 10 as a mitt, as illustrated in FIGS. 1-3, when a user recognizes a need for collecting detritus from an animal before the animal sheds the detritus, the user selects and dons the device 10. The user then pets or rubs the animal with the user's hand in the device 10, allowing the hooks and/or adhesive of the front layer 15 to capture detritus. The user then removes the device 10, turning the device 10 inside-out, and capturing the detritus within the inside-out device 10. The user may then seal the device 10 if the device 10 is equipped with a sealing mechanism. With or without sealing the device 10, the user then disposes of the device 10 and along with it the detritus removed from the animal.

In use of the device 10 as a cover for a grooming tool, when a user recognizes a need for collecting detritus from an animal before the animal sheds the detritus, the user selects an appropriate device 10 and places the device 10 over the grooming tool. The user then pets or rubs the animal with the grooming tool in the device 10, allowing the hooks and/or adhesive of the front layer 15 to capture detritus. The user then removes the device 10, turning the device 10 inside-out, and capturing the detritus within the inside-out device 10. The user may then seal the device 10 if the device 10 is equipped with a sealing mechanism. In this case, the device 10 may also be equipped with a second sealing mechanism to allow the device 10 to be sealed during use to enclose the grooming tool. With or without sealing the device 10, the user then disposes of the device 10 and along with it the detritus removed from the animal.

Other objects and advantages of the present invention will become more apparent to those skilled in the art in view of the following description and the accompanying drawings.

The invention has been described with reference to various specific and illustrative 25 aspects of the present invention and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the appended claims. cm We claim:

1. An animal grooming device comprising:
a front layer including a first material, wherein the front layer has a front layer perimetric edge;
a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool;
a device tip opposite the opening; and
a hair collection mechanism coupled to the front layer, the hair collection mechanism including a section having
a plurality of primary hooks, wherein each primary hook is unidirectional and has an orientation and a primary hook height,
a plurality of secondary hooks, wherein each secondary hook is bidirectional and has a secondary hook height, and
an anchoring layer to which the primary and secondary hooks are attached.

2. The device of claim 1, further comprising a plurality of sections.

3. The device of claim 2, wherein at least one section is positioned on either side of a longitudinal line extending between the opening and the device tip.

4. The device of claim 1, further.comprising a longitudinal line extending between the opening and the device tip, wherein the orientation of each primary hook is away from the longitudinal line.

5. The device of claim 1, further comprising a longitudinal line extending between the opening and the device tip, wherein the front layer is attached to the backing layer at a point on the longitudinal line and spaced apart from a perimetric edge.

6. The device of claim 1, further comprising a longitudinal line extending between the opening and the device tip, wherein the front layer is attached to the backing layer at a stripe extending at least partially along the longitudinal line.

7. The device of claim 1, wherein the section is aligned perpendicularly to a longitudinal line extending between the opening and the device tip.

8. The device of claim 1, wherein the section is generally rectangular.

9. The device of claim 1, wherein the longitudinal line is a centerline.

10. The device of claim 1, further comprising a thumb hole in one of or between the front and backing layers.

11. The device of claim 1, wherein the second material is a nonwoven material.

12. The device of claim 1, wherein the second material is an elastomeric material.

13. The device of claim 1, wherein the first material and the second material are the same material.

14. The device of claim 1, wherein the device is a mitt.

15. The device of claim 1 wherein the device is a grooming tool cover.

16. The device of claim 1, wherein the front layer is coupled to the backing layer using adhesive.

17. The device of claim 1, wherein the front layer is coupled to the backing layer using ultrasonic bonding.

18. The device of claim 1, wherein the front layer is coupled to the backing layer by sewing.

19. The device of claim 1, wherein the device is disposable.

20. The device of claim 1, wherein the secondary hook height is less than about 75 percent of the primary hook height.

21. The device of claim 20, wherein the primary hook height is greater than about 0.25 inches.

22. The device of claim 1, wherein the secondary hook height is less than about 50 percent of the primary hook height.

23. The device of claim 1, wherein the primary hook height is less than about 75 percent of the secondary hook height.

24. The device of claim 1, wherein the primary hook height is less than about 50 percent of the secondary hook height.

25. An animal grooming device comprising:
a front layer including a first material, wherein the front layer has a front layer perimetric edge;
a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool;
a device tip opposite the opening;
a hair collection mechanism coupled to the front layer, the hair collection mechanism including a section including
a plurality of primary hooks, wherein each primary hook is unidirectional and has an orientation,
an anchoring layer to which the primary hooks are attached, wherein each section is aligned in parallel with the opening; and
a longitudinal line extending between the opening and the device tip, wherein the orientation of each primary hook is away from the longitudinal line.

26. The device of claim 25, further comprising a plurality of sections.

27. The device of claim 26, wherein at least one section is positioned on either side of the longitudinal line.

28. The device of claim 25, further comprising a plurality of bidirectional secondary hooks.

29. The device of claim 25, wherein the front layer is attached to the backing layer at a point on the longitudinal line and spaced apart from a perimetric edge.

30. The device of claim 25, wherein the front layer is attached to the backing layer at a stripe extending at least partially along the longitudinal line.

31. The device of claim 25, wherein the section is aligned perpendicularly to the longitudinal line.

32. The device of claim 25, wherein the longitudinal line is a centerline.

33. An animal grooming device comprising:
a front layer including a first material, wherein the front layer has a front layer perimetric edge;
a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool;
a device tip opposite the opening;
a hair collection mechanism coupled to the front layer, the hair collection mechanism including a plurality of sections, each section including
a plurality of primary hooks, wherein each primary hook is unidirectional and has an orientation, and
an anchoring layer to which the primary hooks are attached; and
a longitudinal line extending from the opening to the device tip, wherein the orientation of each primary hook is the same and perpendicular to the longitudinal line, and wherein each section is aligned perpendicularly to the longitudinal line.

34. The device of claim 33, further comprising a plurality of secondary hooks, wherein each secondary hook is bidirectional.

35. A method for controlling animal shedding, the method comprising:
donning. a device having
a front layer including a first material, wherein the front layer has a front layer perimetric edge,
a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool,
a device tip opposite the opening,
a thumb hole in one of or between the front and backing layers, and
a hair collection mechanism coupled to the front layer, the hair collection mechanism including a section including
a plurality of primary hooks, wherein each primary hook is unidirectional and has an orientation,
a plurality of secondary hooks, wherein each secondary hook is bidirectional, and
an anchoring layer to which the primary and secondary hooks are attached;
petting an animal having detritus such that detritus is captured in the hooks; and
disposing of the device.

36. The method of claim 35, further comprising turning the device inside-out to enclose the detritus.

37. An animal grooming device comprising:
a front layer including a first material, wherein the front layer has a front layer perimetric edge;
a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrance to the space by a human hand or a grooming tool;
a device tip opposite the opening;
a hair collection mechanism coupled to the front layer, the hair collection mechanism including a plurality of sections, each section including
a plurality of secondary hooks, wherein each secondary hook is bidirectional, and
an anchoring layer to which the primary and secondary hooks are attached;
a thumb hole in one of or between the front and backing layers; and
a longitudinal line extending between the opening and the device tip,

38. The device of claim 37, wherein each section is aligned perpendicularly to the longitudinal line.

39. The device of claim 37, wherein the front layer is attached to the backing layer at points or a stripe on the longitudinal line.

40. An animal grooming device comprising:
a front layer including a first material, wherein the front layer has a front layer perimetric edge;
a backing layer including a second material, wherein the backing layer has a backing layer perimetric edge, and wherein at least a portion of the backing layer perimetric edge is coupled to the front layer perimetric edge such that the front and backing layers define a bag-like space, the space including an opening sized to allow entrarice to the space by a human hand or a grooming tool;
a device tip opposite the opening;
a hair collection mechanism coupled to the front layer, the hair collection mechanism including a plurality of sections, each section including
a plurality of primary hooks, wherein each primary hook is unidirectional and has an orientation,
a plurality of secondary hooks, wherein each secondary hook is bidirectional, and
an anchoring layer to which the primary and secondary hooks are attached;
a thumb hole in one of or between the front and backing layers; and
a longitudinal line extending between the opening and the device tip, wherein the orientation of each primary hook is away from the longitudinal line, wherein each section is aligned perpendicularly to the longitudinal line, and wherein the front layer is attached to the backing layer at points or a stripe on the longitudinal line.

41. The device of claim 38, wherein the longitudinal line is a centerline.
